(19) United States
(12) Patent Application Publication
(10) Pub. No.: US 2024/0314571 A1
(43) Pub. Date: Sep. 19, 2024

(54) DELEGATED ATTESTATION VIA PROXIMATE LOCATION

(71) Applicant: QUALCOMM Incorporated, San Diego, CA (US)

(72) Inventor: Giridhar Dhati MANDYAM, San Diego, CA (US)

(21) Appl. No.: 18/589,219

(22) Filed: Feb. 27, 2024

Related U.S. Application Data
(60) Provisional application No. 63/489,782, filed on Mar. 13, 2023.

(51) Int. Cl. H04W 12/63; H04W 12/03; H04W 12/108

(52) U.S. Cl. CPC H04W 12/63; H04W 12/03; H04W 12/108

(57) ABSTRACT

Systems and techniques are provided for delegated attestation. For example, a process by an apparatus can include receiving an indication to attest to a property of a target device; generating a measurement associated with the property of the target device; generating data regarding an integrity of the apparatus; generating attestation data, the attestation data including information associated with the generated measurement and the generated data regarding the integrity of the apparatus; and transmitting the attestation data to a verifier device.

### PRIORITY CLAIM

This application claims the benefit of U.S. Provisional Application No. 63/489,782, filed on Mar. 13, 2023, which is hereby incorporated by reference, in its entirety and for all purposes.

### FIELD

The present disclosure generally relates to attestation. For example, aspects of the present disclosure relate to systems and techniques for delegated attestation via proximate location, where a device may attest to a location of another nearby device.

### BACKGROUND

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others.

A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments.

Although wireless communication systems have made great technological advancements over many years, challenges still exist. For example, the mobility enabled by wireless communications systems presents challenges to assuring information about a user device. For example, while a device may be able to assert that the device is at a particular location, the device may be vulnerable to spoofing or other attacks that may cause the device to be mistaken about its actual location. Consequently, it may be useful to allow other devices to assert information about properties of the device to help mitigate or detect potential attacks against a single device.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, methods, apparatuses, and computer-readable media for performing delegated attestation. In one illustrative example, an apparatus for delegated attestation is provided that includes at least one memory and at least one processor (e.g., implemented in circuitry) coupled to the at least one memory. The at least one processor is configured to: receive an indication to attest to a property of a target device; generate a measurement associated with the property of the target device; generate attestation data, the attestation data including information associated with the generated measurement; and transmit the attestation data to a verifier device.

As another example, an apparatus for delegated attestation is provided. The apparatus includes at least one memory comprising instructions and at least one processor coupled to the at least one memory. The at least one processor is configured to: determine to verify a property of a target device; transmit, to an attesting device, a request to perform delegated attestation of the target device; receive, from the attesting device, attestation data, the attestation data including a property associated with a target device, wherein the attesting device is separate from the target device; and verify the property associated with the target device based on an expected property of the target device.

In another example, a method of delegated attestation is provided. The method includes: receiving an indication to attest to a property of a target device; generating a measurement associated with the property of the target device; generating attestation data, the attestation data including information associated with the generated measurement; and transmitting the attestation data to a verifier device.

As another example, a method of delegated attestation is provided. The method includes: determining to verify a property of a target device; transmitting, to an attesting device, a request to perform delegated attestation of the target device; receiving, from the attesting device, attestation data, the attestation data including a property associated with a target device, wherein the attesting device is separate from the target device; and verifying the property associated with the target device based on an expected property of the target device.

In another example, a non-transitory computer-readable medium having stored thereon instructions is provided. The instructions, when executed by at least one processor, cause the at least one processor to: receive an indication to attest to a property of a target device; generate a measurement associated with the property of the target device; generate attestation data, the attestation data including information associated with the generated measurement; and transmit the attestation data to a verifier device.

As another example, a non-transitory computer-readable medium having stored thereon instructions is provided. The instructions, when executed by at least one processor, cause the at least one processor to: determine to verify a property of a target device; transmit, to an attesting device, a request to perform delegated attestation of the target device; receive, from the attesting device, attestation data, the attestation data including a property associated with a target device, wherein the attesting device is separate from the target device; and verify the property associated with the target device based on an expected property of the target device.

In another example, an apparatus for delegated attestation is provided. The apparatus includes: means for receiving an indication to attest to a property of a target device; means for generating a measurement associated with the property of the target device; means for generating attestation data, the attestation data including information associated with the generated measurement; and means for transmitting the attestation data to a verifier device.

As another example, aa apparatus for delegated attestation is provided. The apparatus includes: means for determining to verify a property of a target device; means for transmitting, to an attesting device, a request to perform delegated attestation of the target device; means for receiving, from the attesting device, attestation data, the attestation data including a property associated with a target device, wherein the attesting device is separate from the target device; and means for verifying the property associated with the target device based on an expected property of the target device.

In another example, an apparatus for delegated attestation is provided. The apparatus includes at least one memory comprising instructions and at least one processor coupled to the at least one memory. The at least processor is configured to: receive an indication to attest to a property of a target device; generate a measurement associated with the property of the target device; generate data regarding an integrity of the apparatus; generate attestation data, the attestation data including information associated with the generated measurement and the generated data regarding the integrity of the apparatus; and transmit the attestation data to a verifier device.

As another example, a method for delegated attestation by an apparatus is provided. The method includes: receiving an indication to attest to a property of a target device; generating a measurement associated with the property of the target device; generating data regarding an integrity of the apparatus; generating attestation data, the attestation data including information associated with the generated measurement and the generated data regarding the integrity of the apparatus; and transmitting the attestation data to a verifier device.

In another example, a non-transitory computer-readable medium having stored thereon instructions is provided. The instructions, when executed by at least one processor, cause the at least one processor to receive an indication to attest to a property of a target device; generate a measurement associated with the property of the target device; generate data regarding an integrity of an apparatus; generate attestation data, the attestation data including information associated with the generated measurement and the generated data regarding the integrity of the apparatus; and transmit the attestation data to a verifier device.

As another example, an apparatus for delegated attestation is provided. The apparatus includes: means for receiving an indication to attest to a property of a target device; means for generating a measurement associated with the property of the target device; means for generating data regarding an integrity of the apparatus; means for generating attestation data, the attestation data including information associated with the generated measurement and the generated data regarding the integrity of the apparatus; and means for transmitting the attestation data to a verifier device.

In another example, an apparatus for delegated attestation is provided. The apparatus includes at least one memory comprising instructions and at least one processor coupled to the at least one memory. The at least processor is configured to: determine to verify a property of a target device; transmit, to an attesting device, a request to perform delegated attestation for the target device; receive attestation data, the attestation data including information associated with a property of a target device and data regarding an integrity of the attesting device, wherein the attesting device is separate from the target device; verify the integrity of the attesting device based on the data regarding the integrity of the attesting device; and verify the property associated with the target device based on an expected property of the target device.

As another example, a method for delegated attestation by an apparatus is provided. The method includes: determining to verify a property of a target device; transmitting, to an attesting device, a request to perform delegated attestation of the target device; receiving attestation data, the attestation data including information associated with a property of a target device and data regarding an integrity of the attesting device, wherein the attesting device is separate from the target device; verifying the integrity of the attesting device based on the data regarding the integrity of the attesting device; and verifying the property associated with the target device based on an expected property of the target device.

In another example, a non-transitory computer-readable medium having stored thereon instructions is provided. The instructions, when executed by at least one processor, cause the at least one processor to determine to verify a property of a target device; transmit, to an attesting device, a request to perform delegated attestation for the target device; receive attestation data, the attestation data including information associated with a property of a target device and data regarding an integrity of an attesting device, wherein the attesting device is separate from the target device; verify the integrity of the attesting device based on the data regarding the integrity of the attesting device; and verify the property associated with the target device based on an expected property of the target device

As another example, an apparatus for delegated attestation is provided. The apparatus includes: means for determining to verify a property of a target device; means for transmitting, to an attesting device, a request to perform delegated attestation of the target device; means for receiving attestation data, the attestation data including information associated with a property of a target device and data regarding an integrity of the attesting device, wherein the attesting device is separate from the target device; means for verifying the integrity of the attesting device based on the data regarding the integrity of the attesting device; and means for verifying the property associated with the target device based on an expected property of the target device.

In some aspects, one or more of the apparatuses described herein is, is a part of, or includes a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device or system of a vehicle), or other device. In some aspects, the apparatus includes at least one camera for capturing one or more images or video frames. For example, the apparatus can include a camera (e.g., an RGB camera) or multiple cameras for capturing one or more images and/or one or more videos including video frames. In some aspects, the apparatus includes a display for displaying one or more images, videos, notifications, or other displayable data. In some aspects, the apparatus includes a transmitter configured to transmit one or more video frame and/or syntax data over a transmission medium to at least one device. In some aspects, the processor includes a neural processing unit (NPU), a central processing unit (CPU), a graphics processing unit (GPU), or other processing device or component.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating an attesting system, in accordance with some examples;

FIG. 5 is a block diagram illustrating a system for delegated attestation, in accordance with some examples;

FIG. 6 is a flow diagram illustrating an example of a process for delegated attestation, in accordance with aspects of the present disclosure;

FIG. 7 is a flow diagram illustrating another example of a process for delegated attestation, in accordance with aspects of the present disclosure;

FIG. 8 is a diagram illustrating an example of a computing system, according to aspects of the disclosure.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

In some cases, a wireless device, such as user equipment (UE), may be capable of attesting about the integrity of hardware of, and/or software executing on, the wireless device. As used herein attestation is a process by which software executing on a device provides an assertion (e.g., information) to a relying party about the integrity of the platform. Examples for the assertion may include a hash of the application, a measurement of an operating system kernel, cryptographic function, security software, etc., or a measurement of another software/hardware of the wireless device (e.g., attesting party). This attestation may help provide assurance to a relying party that the wireless device has not been compromised prior to performing certain functionality, such as processing a payment or accessing financial information. While a wireless device may attest to the integrity of the hardware and software of the wireless device, it may be useful to extend attestation to allow another device to attest as to properties of the wireless device.

Systems, apparatuses, electronic devices, methods (also referred to as processes), and computer-readable media (collectively referred to herein as “systems and techniques”) are described herein for delegated attestation via proximate location whereby a device may attest to a property, such as a location, of another device. Delegated attestation allows a separate device (e.g., reader, attesting party, attesting device) to provide attestation information about a property (e.g., the location) of another device (e.g., target device) to a relying party. For example, an attesting device may utilize ranging to measure a distance between the attesting device and the target device. The attesting device may determine the location of the attesting device. Based on the location of the attesting device, the attesting device may estimate a location for the target device. The attesting device may then generate attestation data including the estimated location of the target device and transmit the attestation data to a relying party (or verifier) for verification of the estimated location. In some cases, the attestation data may include the location of the attesting device and the estimated location of the target device may be relative to the location of the attesting device. In some cases, the verifier may verify the estimated location based on a location of the attestor or a location as attested by the target device.

Additional aspects of the present disclosure are described in more detail below.

Wireless networks are deployed to provide various communication services, such as voice, video, packet data, messaging, broadcast, and the like. A wireless network may support both access links for communication between wireless devices. An access link may refer to any communication link between a client device (e.g., a user equipment (UE), a station (STA), or other client device) and a base station (e.g., a 3GPP gNodeB (gNB) for 5G/NR, a 3GPP eNodeB (eNB) for LTE, a Wi-Fi access point (AP), or other base station) or a component of a disaggregated base station (e.g., a central unit, a distributed unit, and/or a radio unit). In one example, an access link between a UE and a 3GPP gNB may be over a Uu interface (e.g., air interface between a UE and a radio access network (RAN)). In some cases, an access link may support uplink signaling, downlink signaling, connection procedures, etc.

In some aspects, wireless communications networks may be implemented using one or more modulation schemes. For example, a wireless communication network may be implemented using a quadrature amplitude modulation (QAM) scheme such as 16 QAM, 32 QAM, 64 QAM, etc.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs may communicate with a core network via a RAN, and through the core network the UEs may be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs may send signals to a base station is called an uplink (UL) channel (e.g., a reverse traffic channel, a reverse control channel, an access channel, etc.). A communication link through which the base station may send signals to UEs is called a downlink (DL) or forward link channel (e.g., a paging channel, a control channel, a broadcast channel, or a forward traffic channel, etc.). The term traffic channel (TCH), as used herein, may refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

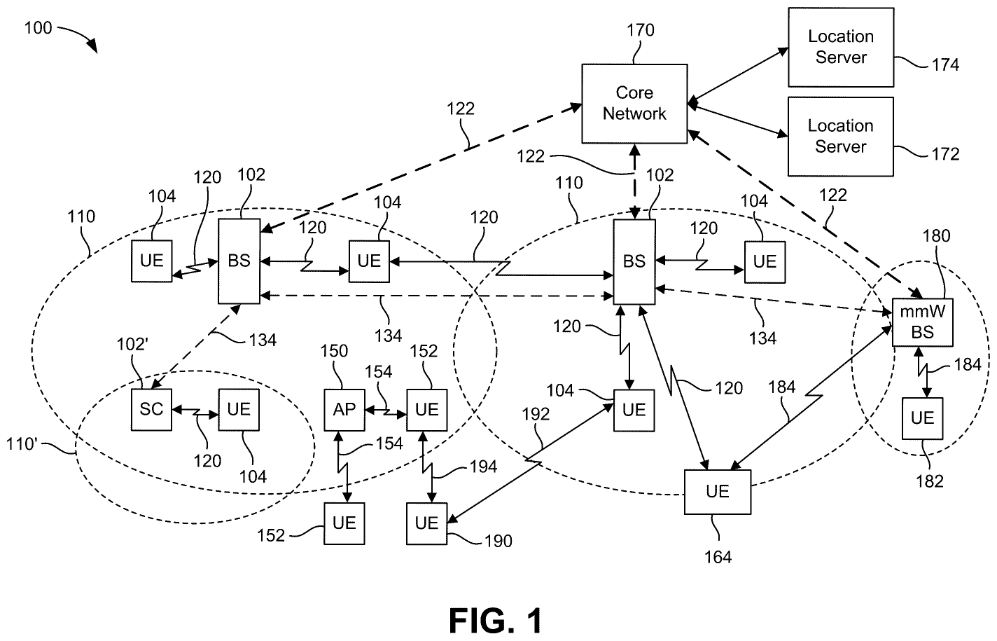

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) may include various base stations 102 and various UEs 104. In some aspects, the base stations 102 may also be referred to as “network entities” or “network nodes.” One or more of the base stations 102 may be implemented in an aggregated or monolithic base station architecture. Additionally, or alternatively, one or more of the base stations 102 may be implemented in a disaggregated base station architecture, and May include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170 ). The UEs 104 may be able to access one or more remote servers 174 via the base stations 102 and core network 170, and in some cases, the other networks, such as the Internet. In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 may include devices (e.g., UEs, etc.) that communicate with one or more UEs 104, base stations 102, APs 150, etc. utilizing the ultra-wideband (UWB) spectrum. The UWB spectrum may range from 3.1 to 10.5 GHZ.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHZ), FR3 (above 52600 MHZ), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like may be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHZ) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHZ aggregated carriers in a multi-carrier system would theoretically lead to a two-fold increase in data rate (i.e., 40 MHZ), compared to that attained by a single 20 MHz carrier.

In order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that may be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 may measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

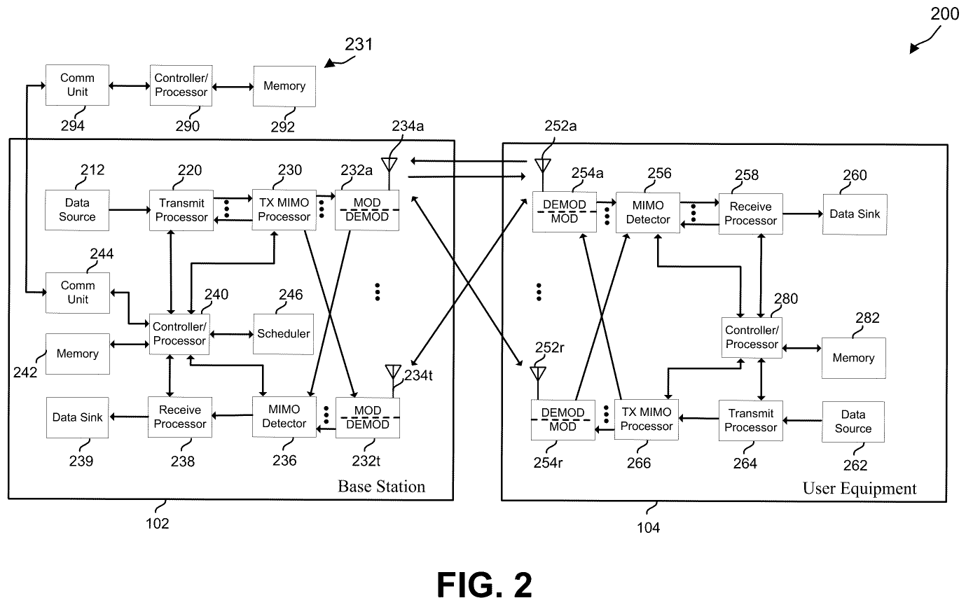

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators may be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals may be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators may be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

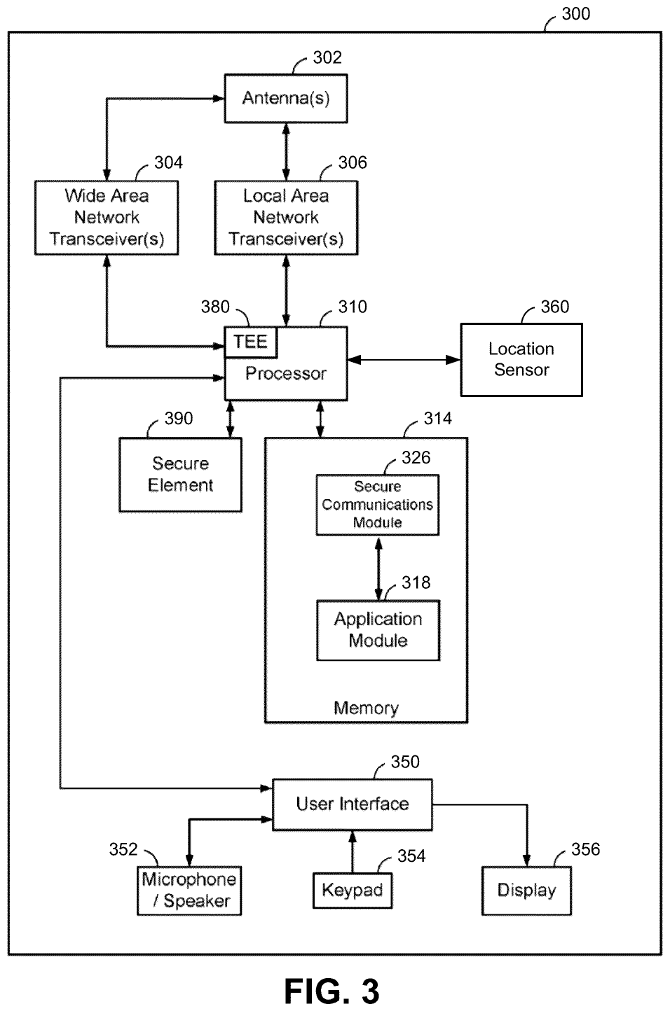

FIG. 3 is a diagram illustrating an example wireless device 300. The wireless device 300 may include a client device such as a UE (e.g., UE 104, UE 152, UE 190) or other type of device (e.g., a station (STA) configured to communication using a Wi-Fi interface) that may be used by an end-user. For example, the wireless device 300 may include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IoT) device, access point, point of sale device, and/or another device that is configured to communicate over a wireless communications network.

As shown, the wireless device 300 may include one or more local area network transceivers 306 that may be connected to one or more antennas 302. The one or more local area network transceivers 306 comprise suitable devices, circuits, hardware, and/or software for communicating with and/or detecting signals to/from the AP 150, as depicted in FIG. 1, and/or directly with other wireless devices, such as UE 152, within a network.

The wireless device 300 may also include, in some implementations, one or more wide area network transceiver(s) 304 that may be connected to the one or more antennas 302. The wide area network transceiver 304 may comprise suitable devices, circuits, hardware, and/or software for communicating with and/or detecting signals from one or more of, for example, the BS 102, AP 150, mmW BS 180 as shown in FIG. 1, and/or directly with other wireless devices, such as UE 152, within a network. In some implementations, the wide area network transceiver(s) 304 may comprise a CDMA communication system suitable for communicating with a CDMA network of wireless base stations. In some implementations, the wireless communication system may comprise other types of cellular telephony networks, such as, for example, TDMA, GSM, WCDMA, LTE, NR, and the like. Additionally, any other type of wireless networking technologies may be used, including, for example, WiMax (802.16), Wi-Fi (802.11), and the like.

The processor(s) (also referred to as a controller) 310 may be connected to the local area network transceiver(s) 306 and the wide area network transceiver(s) 304. The processor 310 may include one or more microprocessors, microcontrollers, and/or digital signal processors that provide processing functions, as well as other calculation and control functionality. The processor 310 may be coupled to storage media (e.g., memory) 314 for storing data and software instructions for executing programmed functionality within the mobile device. The memory 314 may be on-board the processor 310 (e.g., within the same IC package), and/or the memory may be external memory to the processor and functionally coupled over a data bus.

In some cases, the processor 310 may be coupled to a location sensor 360. The location sensor 360 may provide information regarding a location of the wireless device 300. In some cases, the location sensor 360 may include a Global Navigation Satellite System (GNSS) receivers or transceivers that are used to determine a location of the wireless device 300. In some cases, the location sensor 360 may estimate a location of the wireless device 300, for example, based on wireless signals received from one or more wireless nodes, such as BS 102, AP 150, mmW BS 180 as shown in FIG. 1.

A number of software engines and data tables may reside in memory 314 and may be utilized by the processor 310 in order to manage both communications with remote devices/nodes (such as the BS 102, AP 150, mmW BS 180 as shown in FIG. 1), perform positioning determination functionality, and/or perform device control functionality. In some embodiments, the memory 314 may include an application engine 318 and a secure communications engine 326. It is to be noted that the functionality of the modules and/or data structures may be combined, separated, and/or be structured in different ways depending upon the implementation of the wireless device 300.

The application engine 318 may include a process running on the processor 310 of the wireless device 300, which may request data from one of the other modules of the wireless device 300. Applications typically run within an upper layer of the software architectures and may be implemented in a rich execution environment of the wireless device 300, and may include indoor navigation applications, shopping applications, financial services applications, social media applications, location aware service applications, etc. The applications of the application engine 318 may make use of access tokens to obtain content from a remote server, such as remote server 174 of FIG. 1.

The secure communications engine 326 may be a process running on the processor 310 of the wireless device 300, which may generate attestation information that may be sent to the remote server, such as remote server 174 of FIG. 1. The secure communications engine 326 can also be configured to manage the storage of and access to the access tokens, encryption keys, and attestation information. The secure communications engine 326 may be executed on a processor component of the trusted execution environment (TEE) 380 and/or the secure element 390, where the wireless device 300 includes such components. The functionality of the secure communications engine 326 discussed herein can also be implemented as hardware or a combination of hardware and software. The secure communications engine 326 can be implemented one or more application specific integrated circuits (ASICs), programmable logic devices (PLDs), field programmable gate arrays (FPGAs), or other electronic units designed to perform the functions described herein, or a combination thereof.

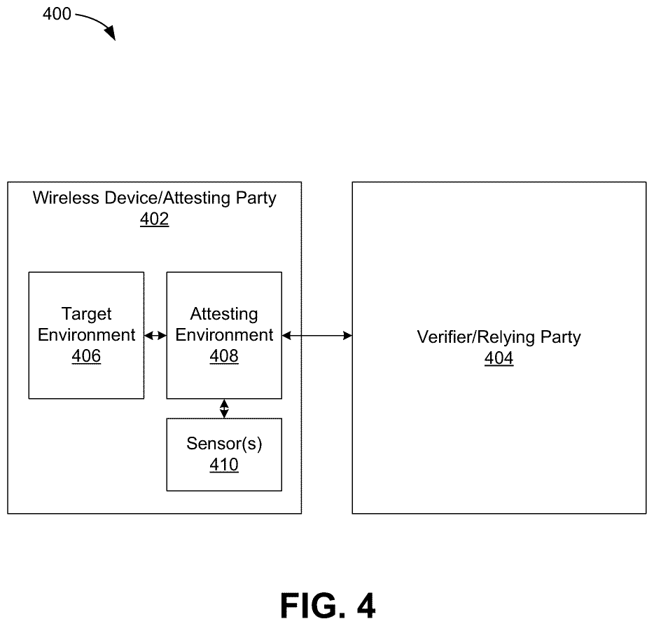

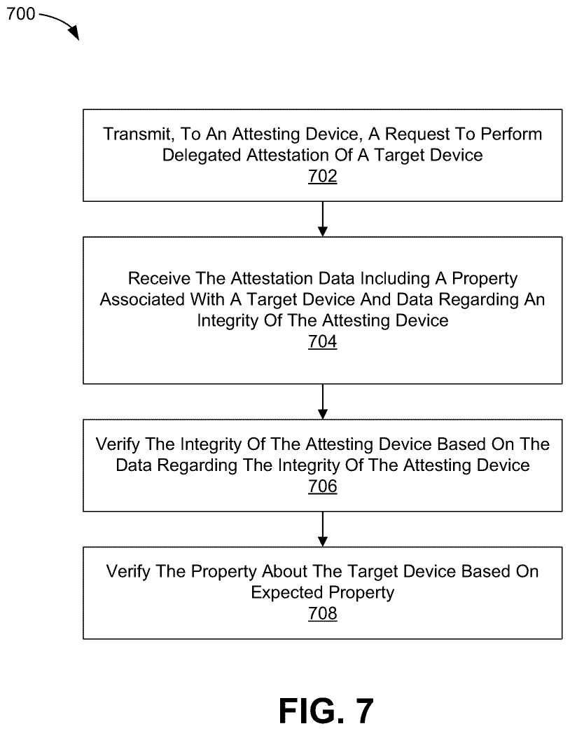

The secure communications engine 326 can be used to implement processes illustrated in FIGS. 4, 5, and 6 for generating attestation data, and the processes illustrated in FIG. 7 for verifying attestation data, unless otherwise indicated.

The processor 310 may also include a trusted execution environment 380. The trusted execution environment 380 can be implemented as a secure area of the processor 310 that can be used to process and store sensitive data in an environment that is segregated from the rich execution environment in which the operating system and/or applications (such as those of the application engine 318) may be executed. The trusted execution environment 380 can be configured to execute trusted applications that provide end-to-end security for sensitive data by enforcing confidentiality, integrity, and protection of the sensitive data stored therein. The trusted execution environment 380 can be used to store encryption keys, access tokens, and other sensitive data.

The wireless device 300 may include a secure element 390 (also referred to herein as a trusted component). The wireless device 300 may include the secure element 390 in addition to or instead of the trusted execution environment 380. The secure element 390 can comprise autonomous and tamper-resistant hardware that can be used to execute secure applications and the confidential data associated with such applications. The secure element 390 can be used to store encryption keys, access tokens, and other sensitive data. The secure element 390 can comprise a Near Field Communication (NFC) tag, a Subscriber Identity Module (SIM) card, or other type of hardware device that can be used to securely store data. The secure element 390 can be integrated with the hardware of the wireless device 300 in a permanent or semi-permanent fashion or may, in some implementations, be a removable component of the wireless device 300 that can be used to securely store data and/or provide a secure execution environment for applications.

The wireless device 300 may further include a user interface 350 providing suitable interface systems, such as a microphone/speaker 352, a keypad 354, and a display 356 that allows user interaction with the wireless device 300. The microphone/speaker 352 provides for voice communication services (e.g., using the wide area network transceiver(s) 304 and/or the local area network transceiver(s) 306). The keypad 354 may comprise suitable buttons for user input. The display 356 may include a suitable display, such as, for example, a backlit LCD display, and may further include a touch screen display for additional user input modes.

FIG. 4 is a block diagram illustrating an attesting system 400, in accordance with aspects of the present disclosure. The attesting system 400 shown in FIG. 4 includes a wireless device 402 and a verifier 404. In some cases, the wireless device 402 may be substantially similar to wireless device 300. The verifier 404 may be a process executing on a networked server which is attempting to verify the integrity (e.g., security state) of the wireless device 402. Attestation may be a process by which an attesting party, such as software executing on a device, such as wireless device 402, provides attestation data to a relying party, such as the verifier 404, about the integrity of the hardware of the wireless device 402 and/or the software executing on the wireless device 402. In some cases, the relying party be a same party as the verifier 404 and the relying party may verify one or more portions of the attestation data. In other cases, the verifier 404 may be separate from the relying party. Attestation data may be provided for attestation by the attesting party (e.g., wireless device 402). The relying party may be any service provider which receives and/or uses the attestation data generated by the attesting party and the verifier 404 may be any service provider which processes the attestation data to determine a veracity of the attestation data. For example, the attestation data may include a hash of an application (e.g., where the attestation data attests that the application has not been changed) and a verifier 404 may check the hash to verify that the hash is equal to an expected value. In some cases, the verifier 404 may indicate to a relying party whether the attesting device may be compromised (e.g., has provided expected/valid attestation data). Of note, while the verifier 404 and the relying party may be separate, for clarity in this discussion, the verifier 404 is assumed to be the relying party.

In some cases, attestation may be performed when an application executing in a target environment 406 of the wireless device 402 attempts to perform certain operations. For example, attestation may be used where an application attempts to access a service that may be performed by platform software, operating system software, and/or applications/drivers with kernel level access. Examples of operations which may need attestation may include installing/removing/modifying software, accessing payment systems, accessing restricted information (e.g., private information, banking information, work information, and the like), or any other operation for which integrity of the device should be assured.

As an example, where there is an attempt to use a payment system application on the wireless device 402, the integrity of the wireless device 402 may be verified before processing a payment. An application executing in the target environment 406 may access the payment system application to make a payment. The payment system application may use a programming interface of an operating system that triggers an attestation procedure to verify the integrity of the wireless device 402. In some cases, a process executing in an attesting environment 408 of the wireless device 402 may gather information (e.g., evidence, claims) regarding the integrity of the wireless device 402, that may, for example, be used by a relying party to decide whether and/or how to interact with the wireless device 402. Examples of attestation data may include information about an operating system kernel, such as versioning information, file hashes, and the like, enumerating third party applications installed on the device, information about the hardware of the wireless device 402, such as signatures, hardware identification numbers, and the like, records of whether suspicious events, such as attempts to access a protected memory space, has occurred, and the like. In some cases, the process(es) executing in the attesting environment 408 may execute on a processor component of the trusted execution environment 380 and/or the secure element 390 of FIG. 3. In some cases, the process(es) executing in the attesting environment 408 of the wireless device 402 may verify certain attestation data. For example, the process(es) executing in the attesting environment 408 may verify file signatures of operating system files, the integrity of the kernel processes, and the like. In some cases, the verifier 404 may verify certain attestation data from the wireless device 402. For example, the verifier 404 may check if there are certain known malicious/suspicious/banned applications installed, if there are an unusual number of attempts to access certain memory spaces, or other such security checks.

In some cases, the attestation data may include information from one or more sensors 410 of the wireless device 402. For example, the attestation data may include location information, for example from a location sensor 360 of FIG. 3, indicating where the wireless device 402 is located when attestation procedure was triggered by accessing the payment system. In some cases, the attestation data may also include an indication of whether the location data may be trusted. For example, the attestation data may include information about the location sensor, confidence information about the location data, whether location data was obtained from multiple sources, whether location data obtained from multiple sources agree as to the location, and the like.

Information for verifying the integrity of the wireless device 402 may be attestation data. In some cases, the attestation data may be used to form an attestation statement, which may be transmitted to a relying party (e.g., if the relying party is not the verifier 404). The attestation statement may be a message including a set of measurements (e.g., attestation data) made by the attesting device. In some cases, the attestation statement may be signed and/or encrypted such that the attestation statement may be cryptographically verified.

After the attestation statement is verified and contents of the attestation statement evaluated by the verifier 404, if the verifier 404 determines that the integrity of the wireless device 402 has been maintained, the verifier 404 (or relying party) may send an indication to the attesting environment 408, that the process triggering the attestation procedure (e.g., accessing the payment system) may proceed. If the verifier 404 determines that the integrity of the wireless device 402 has not been maintained, the verifier 404 (or relying party) may send an indication to the attesting environment 408, that the process triggering the attestation procedure (e.g., accessing the payment system) may not proceed.

In some cases, a wireless device may be configured to perform ranging. For ranging, a reader device may be able to receive messages from a wireless device and detect a relative location (e.g., distance and/or direction between the reader device and the wireless device) of the wireless device. In some cases, a reader device may be a wireless device which receives a wireless transmission from another wireless device in the context of authentication. For example, a reader device may be an IoT device such as a door lock, car, point of sale device, etc., which receives an authentication request from another wireless device. In some cases, ranging may be used to determine whether the other wireless device is within a threshold distance for authorizing the other device. For example, the reader device may determine a relative location of the other wireless device and if that relative location is within a certain threshold distance, then the reader device may authorize the other device.

In some cases, relative location may be determined by the reader device, for example, using time of flight (ToF) estimation based on a scrambled and/or encoded time stamp sequence. In some cases, the ToF may be determined based on how long the wireless device takes to respond to ranging messages from the reader device. The distance may then be determined based on the ToF and a known amount of time needed for the wireless device to receive, process, and transmit a response to ranging messages. Once a reader device has determined that the wireless device is within a threshold distance via ranging, the reader device may perform an action requested by the wireless device, such as unlock a door, perform a payment transaction, and the like.

In some cases, it may be useful extend ranging to allow a device, such as the reader, to attest to the location of another device (e.g., target device) via delegated attestation. Delegated attestation allows a separate device (e.g., reader, attesting party) to provide attestation information about a property (e.g., the location) of another device (e.g., target device) to a relying party (e.g., verifier). In some cases, the property may be a physical property that can be measured/perceived remotely. Delegated attestation may be useful to detect and/or protect against a compromised target device as the attesting party (e.g., reader) is not a part of and/or integrated with the target device (e.g., a target of the attestation). Of note, while described in context of delegated attestation of a location of a target device, it may be understood that the concept of delegated attestation may be applied to any other property of a target device perceptible by a separate device. For example, the attesting device may be able to measure/perceive physical properties of the target device, such as an appearance, temperature, weight, physical dimensions, etc. and may provide attestation information about such physical properties of the target device to the relying party.

As an example of delegated attestation, when there is an attempt, by a target device, to access information (e.g., financial information, health information, other potentially sensitive or restricted information) on a system of a party (e.g., relying party) that uses delegated attestation, such as a payment system application, a verifying party (e.g., relying party) may verify some property (e.g., an attested property) of the target device. For example, the attesting party (e.g., reader device) may attest that the target device is in particular location and the verifying party May verify whether the location is consistent with the expected location. In some cases, this expected location (e.g., attested property) may be predetermined (e.g., the relying party may expect the target device to be at predetermined locations). In some cases, the target device may provide the verifying party information about the attested property, such as location information, that the verifying party may verify. In some cases, the target device may attest to the attested property. The requested information may be provided to the target device after the information about the attested property is verified.

In some cases, the verifying party may use the attested property, such as the location information, to locate an attestation device, such as nearby payment kiosk. The verifying party may send the target device an indication to distinguish the target device so the reader device may find the target device. For example, to access a kiosk and/or account, the verifying party may indicate to the target device and/or attesting device to perform ranging for delegated attestation by the attesting party. The verifying party may send the attesting device a request to perform delegated attestation of the target device. For example, the verifying party may indicate to the attesting device to perform ranging with the target device. The attesting device may then obtain information about the target device, such as a measurement of the target device, generate attestation data based on the obtained information about the target device as one or more attested properties, and send the attestation data to the verifying party. The verifying party may then receive the attestation data including the one or more attested properties. The verifying party may then compare the one or more attested properties about the target device to one or more expected properties to verify the target device. The requested access may be provided after the attested property is verified.

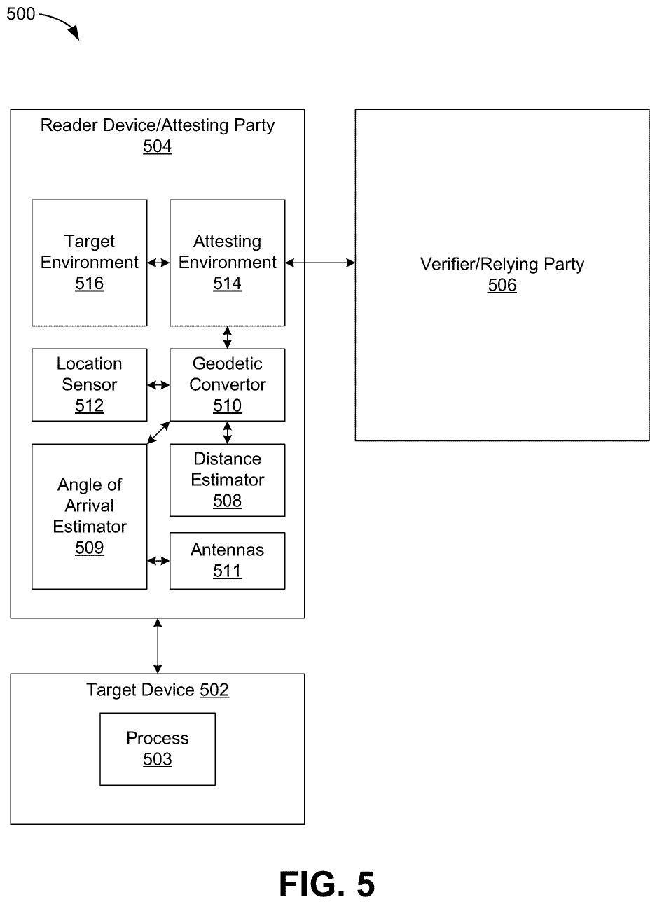

FIG. 5 is a block diagram illustrating a system 500 for delegated attestation, in accordance with aspects of the present disclosure. In system 500, a target device 502 may be executing a process 503 that may attempt to verify a location of the target device 502 using delegated attestation. For example, a process 503, such as a payment application, may attempt to verify that the target device 502 is located at a certain store or in a user's home using delegated attestation via a separate reader device 504. In delegated attestation, a separate reader device, such as reader device 504, may attest to the location of the target device 502 and/or the location of the reader device 504. As an example, the reader device 504 may receive a request to initiate a delegated attestation process for the target device 502. This request to initiate the delegated attestation process may be received from either the target device 502, a verifier 506, and/or another device. Delegated attestation may include generating one or more measurements about a property of the target device 502. For example, the reader device 504 may measure a distance and/or angle of arrival of the target device 502 for delegated attestation. Based on the measurements, the attesting party (e.g., reader device 504) may generate attestation data. In some cases, the attestation data may include the measured distance, angle of arrival information, an indication of the distance and/or angle of arrival information (e.g., distance/angle bins/Booleans), and/or information for determining the distance or angle of arrival. In other cases, the attestation data may include a location of the target device 502. In some cases, when the reader device 504 attests to the location of a target device 502, the reader device 504 may attest to an estimated location of the target device 502 in a geodetic coordinate system, as well as a unique identifier (ID) for the target device 502. The attestation data may then be sent to the verifier 506 for verification.

To obtain the estimated location of the target device 502, ranging may be performed by the reader device 504 to obtain a measured distance and a measured angle of arrival to the target device 502. The estimated location may be determined based on the measured distance and the measured angle of arrival, along with a current location of the reader device 504. The current location of the reader device 504 may be obtained by a location sensor 512 using any technique for locating the reader device 504. For example, the location of the reader device 504 may be determined through GNSS satellite based systems, such as GPS, GLONASS, GNSS, BDS, and the like, through positioning technologies, such as received signal angle, triangulated positions, ranging, and the like, and/or based on a location of a wireless node, a zone identifier associated with a wireless network, and the like.

In some cases, the reader device 504 may include a distance estimator engine 508 to obtain a distance to the target device 502. The distance estimator engine 508 may perform ranging to determine the distance to the target device 502 and/or an angle of arrival relative to the target device 502. In some cases, any ranging technique may be used to obtain a distance measurement and the measurement of the angle of arrival. As an example, the target device 502 may initiate a ToF determination to estimate a distance to the reader device 504 by transmitting a ranging initiation message to the reader device 504. In response to the ranging initiation message, the reader device 504 may transmit a ranging response message to the target device 502. The target device 502 may respond to the ranging response message with a ranging final message to the reader device 504. The reader device 504 may then perform a ToF determination based on the ranging response message and/or ranging final message to measure (e.g., estimate, determine, etc.) a distance between the reader device 504 and the target device 502.

Similarly, the angle of arrival may be measured using any technique for measuring an angle of arrival of transmissions. For example, the reader device 504 may include an angle of arrival estimator engine 509 coupled to a plurality of antennas 511 (or one or more antenna arrays). The plurality of antennas 511 may be located about the reader device 504 and the antennas of the plurality of antennas 511 may receive messages from the target device 502 at slightly different times. Based on a difference in time between when a message is received from the target device 502 at the antennas of the plurality of antennas 511, the angle of arrival may be measured (e.g., estimate, determine, etc.) by the angle of arrival estimator engine 509. The relative location of the target device 502 from the reader device 504 may then be estimated based on the measured angle of arrival and the measured distance. In some cases, an angle of elevation may also be measured in a manner similar to measuring the angle of arrival.

In some cases, the estimated distance as between the target device 502 and the reader device 504 may not provide a location of the target device 502. That is, the estimated distance indicates how far away the target device 502 is from the reader device, but by itself does not indicate where the target device 502 is on the planet. In some cases, the reader device may include a geodetic convertor engine 510 to determine the location of the target device 502 using geodetic coordinates (e.g., coordinates relative to Earth, such as latitude/longitude coordinates). To determine the location of the target device 502, the geodetic convertor engine 510 may receive location information from a location sensor 512 indicating where the reader device 504 is located. In some cases, the location sensor 512 may be substantially similar to location sensor 360 of FIG. 3. The geodetic converter engine 510 may also receive the determined angle of arrival from the angle of arrival estimator engine 509 and the determined distance from the distance estimator engine 508. In some cases, either the geodetic convertor engine 510, the distance estimator engine 508, the angle of arrival estimator engine 509, or any combination thereof, may execute within the attesting environment 514. Based on the indicated location of the reader device 504, the geodetic convertor engine 510 may estimate the location of the target device 502 using geodetic coordinates.

In some cases, the location of the target device 502 may be estimated based on the indicated location of the reader device 504, the measured angle of arrival, and the measured distance using a projection process. Any projection process may be used. An example projection process may include applying a Haversine formula. The Haversine formula may be expressed as: d/r=2 sin⁻¹(sqrt{sin²((latᵣ−lat_{d})/2)+cos(lonᵣ)cos(lon_{d})sin²((lonᵣ−lon_{d})/2)}), where d represents a distance between the reader device 504 and the target device 502, r represent a radius of the Earth, (latᵣ,lonᵣ) represents the latitude/longitudes coordinates (in degrees) for the reader device 504, and (lat_{d},lon_{d}) represents the latitude/longitudes coordinates (in degrees) for the target device 502.

Another example projection process may include map-based projections, such as a universal transverse Mercator (UTM) transformation. In a UTM transformation, latitude/longitude coordinates may be projected to x/y coordinates for a planar representation of surface of Earth. The planar representation may be sufficient as the curvature of the Earth is likely to be insignificant for the distances involved. In some cases, UTM may divide the Earth into multiple zones which may be referenced by an casting/northing pair for a zone. Assuming an casting/northing pair for the reader device 504 is given as (e,n), and the target device 502 is at measured distance d and measured angle of arrival f, with both endpoints within same UTM zone, a UTM pair (e.g., x/y) (e_{dev},n_{dev}) for the target device 502 may be found as e_{dev}=e+d cos(f) and n_{dev}=n+d sin(f). The UTM pair may then be projected to latitude/longitudes coordinates (e.g., geolocation coordinates or WGS-84 format) as needed. For example, the reader device 504, may obtain its location information in UTM form. Based on the measured angle of arrival, and the measured distance of the target device 502, the reader device 504 may estimate UTM coordinates for the target device 502 as discussed above. The reader device 504 may then transform the estimated UTM coordinates of the target device 502 by projecting the UTM coordinates to geolocation coordinates (e.g., latitude/longitudes coordinates).

In some cases, an attesting party, such as the reader device 504, performing delegated attestation may provide the verifier 506 with an identifier for the target device 502 along with the property (e.g., an estimated property) of the target device 502, such as an estimated location of the target device. In some cases, the target device 502 may transmit a unique ID to the reader device 504. In some cases, the unique ID may be transmitted to the reader device 504 in a transmission in addition to (e.g., separate from) the ranging transmissions. In some cases, the transmission may be performed via a sideband communications channel. For example, the transmission may be performed via a separate radio access technology like Bluetooth, near field communications, a sidelink connection, and the like.

In cases where a unique ID is provided to the reader device 504 by the target device 502, the reader device 504 may include the provided unique ID along with the estimated location (e.g., geodetic coordinates) of the target device 502 in the attestation data sent to the verifier 506. The location data and unique ID (if available) may be included as attestation data that may be encoded into an attestation token for transmission to the verifier 506. For example, the location data and unique ID (if available) may be formatted as a claim of an entity attestation token (EAT). In some cases, the location data may be the projected geolocation coordinates (e.g., latitude/longitudes coordinates). In cases where the projection geolocation coordinates are not determined, the determined distance and angle of arrival may be included in the attestation data, along with a location of the reader device 504. In some cases, the location of the reader device 504 may be sent in a claim of the EAT separate from the location data of the target device 502. In some cases, the angle of elevation may also be included in the attestation data. In some cases, the claim of the EAT attesting to the location of the target device 502 may be referred to as a proximate location claim (proxloc) and formatted as follows:

```
proxloc-type = {
  target-ueid => ueid, (e.g., unique ID of target)
  ? target-location => location ; (e.g., projection geolocation coordinates)
  ? aoa => float ; (e.g., angle of arrival)
  ? distance => float ; (e.g., distance)
  ? aoe =? float ; (e.g., angle of elevation)
}
```

The attestation token may also include attestation data regarding the integrity of the reader device 504. Examples of attestation data regarding the integrity of the reader device 504 may include information about an operating system kernel, such as versioning information, file hashes, and the like, enumerating third party applications installed on the device, information about the hardware of the reader device 504, such as signatures, hardware identification numbers, and the like, records of whether suspicious events, such as attempts to access a protected memory space, has occurred, and the like. In some cases, the attestation token may be cryptographically coded by the reader device 504 for transmission to the verifier 506.

In some cases, the reader device 504 may assign a unique ID to the target device 502. For example, the reader device 504 may be associated with the target device 502 during a setup or paring procedure and the unique ID may be shared by the reader device 504 to the target device 502 (or vice versa). The target device 502 may then transmit this assigned unique ID to the reader device 504 for delegated attestation in manner substantially similar to that discussed above.

After receiving the attestation token, the verifier 506 may determine whether the property of the target device 502 is consistent with an expected property of the target device 502. For example, the verifier 506 may determine whether the estimated location of the target device 502 is consistent with an expected location of the target device 502. If the property matches or is consistent with the expected property (e.g., the estimated location matches the expected location), the verifier 506 can send an indication to either the reader device 504 or the target device 502 to enable execution of the process which triggered the delegated attestation.

In some cases, such as where the reader device 504 is configured to use ultrawide band (UWB) ranging, the reader device may use a ranging session specific identifier, such as a UWB ranging session key as a unique ID for the target device. The reader device 504 may then include the ranging session specific identifier as the unique ID in the attestation data transmitted to the verifier 506. As the ranging session specific identifier may be known to both the reader device 504 and the target device 502, the target device 502 may separately transmit the ranging session specific identifier to the verifier 506 for location verification.

In some cases, the attestation data may also include information about the target environment 516 of the reader device 504. In some cases, the information about the target environment 516 of the reader device 504 may be obtained in a substantially similar manner as discussed above with respect to FIG. 4.

In some cases, delegated attestation of the location of the target device 502 may be performed by the reader device 504 along with attestation by the target device 502 of its location. The reader device 504 and the target device 502 may both send attestation data including location information and the verifier 506 (e.g., relying party) may correlate the estimated location information from the reader device 504 with the location information from the target device 502.

In some cases, the reader device 504 may receive location information from the target device 502. The reader device 504 may then compare the received location information with the estimated location information determined by the reader device 504 to perform a trustworthiness assessment of the target device (e.g., whether the location information received from the target device 502 matches or is near to the estimated location).

In some cases, the verifier 506 may verify the attestation data received from the attesting device (e.g., the reader device 504). In addition to verifications discussed above with respect to FIG. 4, the verifier 506 may verify one or more properties about the target device 502 based on the attestation data. As an example, where a property for the target device includes the location of the target device, the verifier 506 may verify that the target device 502 is located in an expected location, such as in a user's home/work, is near a particular reader device 504, or the like. In some cases, the verifier 506 may receive attestation data from both the reader device 504 and the target device 502. In such a case, the verifier 506 may verify that the estimated location of the target device 502 is nearby a location of the reader device 504 based on a comparison of the estimated location of the target device 502 and the location of the reader device 504. In some cases, the verifier 506 may verify that the estimated location of the target device 502 is consistent with historical estimated locations (e.g., previous locations). For example, if the estimated location of the target device 502 is in France, but an hour ago the estimated location was attested to as being in Ohio, then verification may fail.

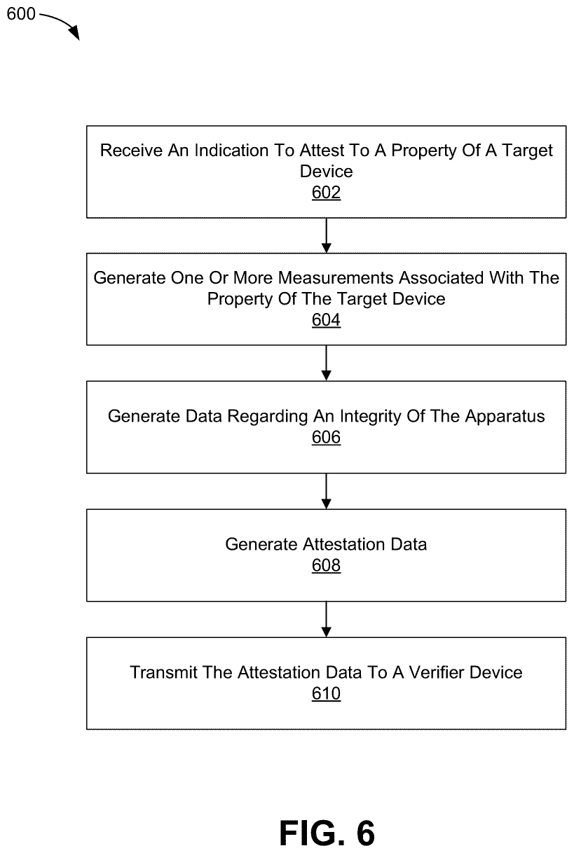

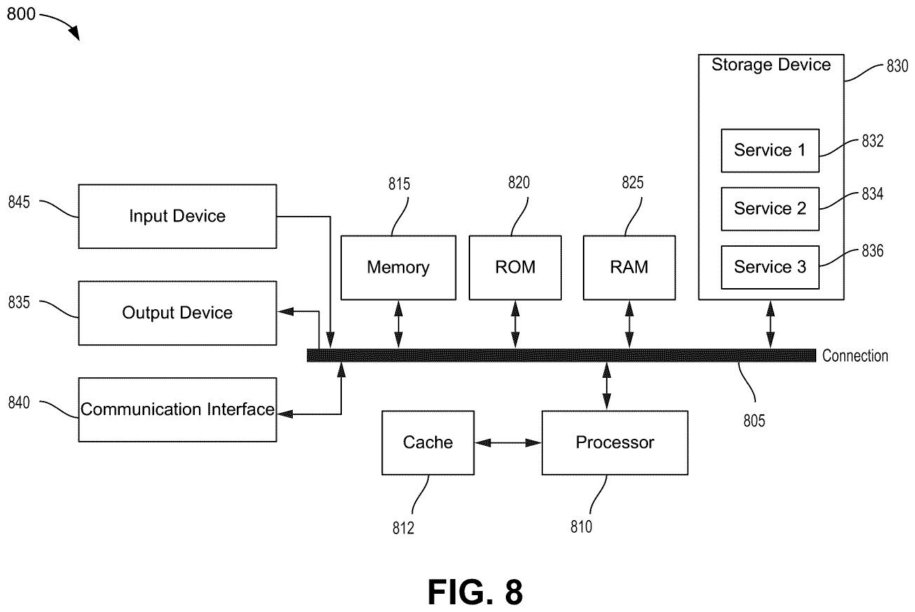

FIG. 6 is a flow diagram of a process 600 for delegated attestation, in accordance with aspects of the present disclosure. The process 600 may be performed by a computing device (or apparatus), such as a reader device 504 (e.g., attesting party) of FIG. 5, or a component (e.g., a chipset, codec, processor 310 of FIG. 3, secure clement 390 of FIG. 3, processor 810 of FIG. 8, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 600 may be implemented as software components that are executed and run on one or more processors. In some cases, the computing device may include an indication, such as a configuration, that the UE may use an enhanced privacy technique, such as techniques discussed in accordance with aspects of the present disclosure.

At block 602, the computing device (or component thereof) may receive an indication to attest to a property of a target device. In some cases, the property of the target device comprises a location of the target device.

At block 604, the computing device (or component thereof) may generate a measurement associated with the property of the target device. In some cases, the computing device (or component thereof) may generate the measurement by measuring (e.g., using distance estimator engine 508 of FIG. 5) a distance to the target device. In one illustrative example, the distance to the target device is measured based on a time of flight of messages received from the target device. Additionally or alternatively, in some cases, the computing device (or component thereof) may generate the measurement by measuring (e.g., using distance estimator engine 508 of FIG. 5) an angle of arrival of the target device.

At block 606, the computing device (or component thereof) may generate data regarding an integrity of the apparatus. In some cases, the data regarding the integrity of the apparatus may include a hash of an application, a measurement of an operating system kernel, cryptographic function, security software, etc., or a measurement of other software/hardware of the computing device (e.g., attesting party).

At block 608, the computing device (or component thereof) may generate attestation data. In some cases, the attestation data including information associated with the generated measurement and the generated data regarding the integrity of the apparatus. In some aspects, the computing device (or component thereof) may generate the attestation data by determining (e.g., using the geodetic convertor engine 510, distance estimator engine 508, and/or angle of arrival estimator engine 509 of FIG. 5) the location of the target device based on the measured distance and the angle of arrival. In some examples, the information associated with the generated measurement comprises the location of the target device. In some cases, the information associated with the generated measurement includes the measured distance of the target device, and the angle of arrival. In some examples, the computing device (or component thereof) may determine the location of the target device by receiving location information. For example, the target device may receive location information from a GNSS system of the target device or an external GNSS system. In one illustrative example, the received location information is in a universal transverse Mercator (UTM) format. In some cases, the location information indicates a location of the apparatus. In some examples, the computing device (or component thereof) may determine (e.g., estimate, measure, etc.) the location of the target device in the UTM format based on the received location information, the measured distance of the target device, and the angle of arrival. In some cases, the attestation data includes the determined location of the target device. In some aspects, the computing device (or component thereof) may determine the location of the target device based on the measured distance of the target device and the angle of arrival. In some examples, the computing device (or component thereof) may project the determined location of the target device to geolocation coordinates. In some cases, the computing device (or component thereof) may receive an identifier from the target device. In some examples, the attestation data includes the received identifier. In some aspects, the identifier comprises a unique identifier of the target device, an assigned identifier assigned to the target device by the apparatus, a ranging session identifier, any combination thereof, and/or other information. In some cases, the attestation data comprises an attestation statement that is encrypted and signed. Referring to FIG. 5 as one illustrative example, based on the measurements (e.g., the determined distance, the measured distance, and/or the measured angle), the attesting party (e.g., reader device 504) may generate attestation data based on the measurements. In some cases, when the reader device 504 attests to the location of a target device 502, the reader device 504 may attest to the determined location of the target device 502 in a geodetic coordinate system, as well as a unique identifier (ID) for the target device 502.

At block 610, the computing device (or component thereof) may transmit the attestation data to a verifier device (e.g., verifier 404 of FIG. 4, verifier 506 of FIG. 5, or other verifier device).

In some examples, the processes described herein (e.g., process 600 and/or other process described herein) may be performed by a computing device or apparatus (e.g., a UE or a base station). In another example, the process 600 may be performed by the UE 104 of FIG. 1. In another example, the process 600 may be performed by a computing device with the computing system 800 shown in FIG. 8.

FIG. 7 is a flow diagram of a process 700, for delegated attestation, in accordance with aspects of the present disclosure. The process 700 may be performed by a computing device (or apparatus), such as a verifier 506 (e.g., verifying party) of FIG. 5, or a component (e.g., a chipset, codec, processor 310 of FIG. 3, secure clement 390 of FIG. 3, processor 810 of FIG. 8, etc.) of the computing device. The computing device may be a mobile device (e.g., a mobile phone), a base station (e.g., BS 102 of FIG. 1), a network server coupled to core network such as core network 170 of FIG. 1, a network-connected wearable such as a watch, an extended reality (XR) device such as a virtual reality (VR) device or augmented reality (AR) device, a vehicle or component or system of a vehicle, or other type of computing device. The operations of the process 700 may be implemented as software components that are executed and run on one or more processors. In some cases, the computing device may include an indication, such as a configuration, that the UE may use an enhanced privacy technique, such as techniques discussed in accordance with aspects of the present disclosure.

At block 702, the computing device (or component thereof) may determine to verify a property of a target device (e.g., target device 502 of FIG. 5). In some cases, the property of the target device comprises a location of the target device. In some cases, the expected property of the target device comprises an expected location of the target device. In some cases, the location of the target device is based on a location of the attesting device.

At block 704, the computing device (or component thereof) may transmit, to an attesting device (e.g., reader device 504 of FIG. 5), a request to perform delegated attestation of the target device.

At block 706, the computing device (or component thereof) may receive attestation data. In some cases, the attestation data includes information associated with a property of a target device and data regarding an integrity of the attesting device. In some cases, the attesting device is separate from the target device. In some cases, the attestation data further includes the location of the attesting device. In some cases, the computing device (or component thereof) may verify the property associated with the target device by determining whether the location of the target device and the location of the attesting device are within a threshold distance. In some cases, the attestation data includes an identifier associated with the target device. In some cases, the identifier comprises at least one of: a unique identifier of the target device; an assigned identifier assigned to the target device by the apparatus; and a ranging session identifier. In some cases, the attestation data further includes data regarding an integrity of the apparatus. In some cases, the property of the target device comprises a location of the target device, the attestation data further includes the location of the target device, information associated with a property of a target device includes a measured distance of the target device, and an angle of arrival, and wherein the computing device (or component thereof) may determine the location of the target device based on the location of the target device, the measured distance of the target device, and the angle of arrival.

At block 708, the computing device (or component thereof) may verify the integrity of the attesting device based on the data regarding the integrity of the attesting device. For example, a verifying party, such as verifier 404, may check the data to verify the data regarding the integrity of the attesting device is consistent with expected data. As a more specific example, the verifying party may check that a hash (e.g., of an application, software, OS, etc.) is equal to an expected value (or within a range of expected values).

At block 710, the computing device (or component thereof) may verify the property associated with the target device based on an expected property of the target device. In some cases, the computing device (or component thereof) may compare the location of the target device to the expected location of the target device. In some cases, the expected location of the target device is based on a previous location of the target device. In some examples, the expected location comprises the location of the attesting device. In some cases, the expected property of the target device is received from the target device. In some cases, the computing device (or component thereof) may determine to verify the property of the target device by receiving a request to access information. In some cases, the computing device (or component thereof) may determine to verify the property of the target device by determining to verify the property of the target device based on the request to access the information. In some cases, the expected property is received as attestation data from the target device. In some cases, the computing device (or component thereof) may provide the information based on verifying (e.g., a verification of) the property associated with the target device.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the processes 600, 700, and/or other processes described herein may include a processor, microprocessor, micro-computer, or other component of a device that is configured to carry out the steps of the processes 600, 700, and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the processes 600, 700, and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

Process 600 and process 700 are illustrated as a logical flow diagrams, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the processes 600, 700, and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory. FIG. 8 is a diagram illustrating an example of a system for implementing certain aspects of the present technology. In particular, FIG. 8 illustrates an example of computing system 800, which may be for example any computing device making up internal computing system, a remote computing system, a camera, or any component thereof in which the components of the system are in communication with each other using connection 805. Connection 805 may be a physical connection using a bus, or a direct connection into processor 810, such as in a chipset architecture. Connection 805 may also be a virtual connection, networked connection, or logical connection.

In some embodiments, computing system 800 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 800 includes at least one processing unit (CPU or processor) 810 and connection 805 that communicatively couples various system components including system memory 815, such as read-only memory (ROM) 820 and random access memory (RAM) 825 to processor 810. Computing system 800 may include a cache 812 of high-speed memory connected directly with, in close proximity to, or integrated as part of processor 810.

Processor 810 may include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which may represent any number of input mechanisms, such as a microphone for speech, a touch-sensitive screen for gesture or graphical input, keyboard, mouse, motion input, speech, etc. Computing system 800 may also include output device 835, which may be one or more of a number of output mechanisms. In some instances, multimodal systems may enable a user to provide multiple types of input/output to communicate with computing system 800.

Computing system 800 may include communications interface 840, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 830 may include software services, servers, services, etc., that when the code that defines such software is executed by the processor 810, it causes the system to perform a function. In some embodiments, a hardware service that performs a particular function may include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus for delegated attestation, comprising: at least one memory comprising instructions; and at least one processor coupled to the at least one memory and configured to: receive an indication to attest to a property of a target device; generate a measurement associated with the property of the target device; generate attestation data, the attestation data including information associated with the generated measurement; and transmit the attestation data to a verifier device.

Aspect 2. The apparatus of Aspect 1, wherein the property of the target device comprises a location of the target device.

Aspect 3. The apparatus of Aspect 2, wherein, to generate the measurement, the at least one processor is configured to: measure a distance to the target device; and measure an angle of arrival of the target device.

Aspect 4. The apparatus of Aspect 3, wherein the at least one processor is configured to measure the distance to the target device based on a time of flight of messages received from the target device.

Aspect 5. The apparatus of any one of Aspects 3 or 4, wherein, to generate the attestation data, the at least one processor is configured to estimate a location of the target device based on the measured distance and the angle of arrival.

Aspect 6. The apparatus of Aspect 5, wherein, to generate the attestation data, the at least one processor is further configured to: receive location information, the location information indicating a location of the apparatus; and estimate a location of the target device based on the received location information, the estimated distance of the target device, and the angle of arrival.

Aspect 7. The apparatus of Aspect 6, wherein the attestation data includes the estimated location of the target device.

Aspect 8. The apparatus of any one of Aspects 6 or 7, wherein the received location information is in a universal transverse Mercator (UTM) format and wherein the at least one processor is configured to: estimate the location of the target device based on the estimated distance of the target device and the angle of arrival; and project the estimated location of the target device to geolocation coordinates.

Aspect 9. The apparatus of any of Aspects 1-8, wherein the at least one processor is configured to receive an identifier from the target device, and wherein the attestation data includes the received identifier.

Aspect 10. The apparatus of Aspect 9, wherein the identifier comprises at least one of: a unique identifier of the target device; an assigned identifier assigned to the target device by the apparatus; and a ranging session identifier.

Aspect 11. The apparatus of any of Aspects 1-10, wherein the attestation data comprises an attestation statement that is encrypted, signed, and includes data regarding an integrity of the apparatus.

Aspect 12. An apparatus for delegated attestation, comprising: at least one memory comprising instructions; and at least one processor coupled to the at least one memory and configured to: determine to verify a property of a target device; transmit, to an attesting device, a request to perform delegated attestation of the target device; receive, from the attesting device, attestation data, the attestation data including a property associated with a target device, wherein the attesting device is separate from the target device; and verify the property associated with the target device based on an expected property of the target device.

Aspect 13. The apparatus of Aspect 12, wherein the property of the target device comprises a location of the target device, and wherein the expected property of the target device comprises an expected location of the target device.

Aspect 14. The apparatus of Aspect 13, wherein the location of the target device is based on a location of the attesting device.

Aspect 15. The apparatus of Aspect 14, wherein the attestation data further includes the location of the attesting device, and wherein the at least one processor is further configured to determine whether the location of the target device and the location of the attesting device are within a threshold distance.

Aspect 16. The apparatus of any one of Aspects 13-15, wherein the at least one processor is further configured to compare the location of the target device to the expected location of the target device.

Aspect 17. The apparatus of Aspect 16, wherein the expected location of the target device comprises a previous location of the target device.

Aspect 18. The apparatus of any of Aspects 12-17, wherein the attestation data includes an identifier associated with the target device.

Aspect 19. The apparatus of Aspect 18, wherein the identifier comprises at least one of: a unique identifier of the target device; an assigned identifier assigned to the target device by the apparatus; and a ranging session identifier.

Aspect 20. The apparatus of any of Aspects 12-19, wherein the attestation data further includes data regarding an integrity of the apparatus.

Aspect 21. The apparatus of any of Aspects 12-20, wherein the expected property of the target device is received from the target device and wherein, to determine to verify the property of the target device, the at least one processor is further configured to: receive a request to access information; and determine to verify the property of the target device based on the request to access the information.

Aspect 22. The apparatus of Aspect 21, wherein the expected property is received as attestation data from the target device.

Aspect 23. The apparatus of any one of Aspects 21 or 22, wherein the at least one processor is configured to provide the information based on verifying the property associated with the target device.

Aspect 24. A method for delegated attestation by an apparatus, comprising: receiving an indication to attest to a property of a target device; generating a measurement associated with the property of the target device; generating attestation data, the attestation data including information associated with the generated measurement; and transmitting the attestation data to a verifier device.

Aspect 25. The method of Aspect 24, wherein the property of the target device comprises a location of the target device.

Aspect 26. The method of Aspect 25, wherein generating the measurement comprises: measuring a distance to the target device; and measuring an angle of arrival of the target device.

Aspect 27. The method of Aspect 26, wherein the distance to the target device is measured based on a time of flight of messages received from the target device.

Aspect 28. The method of any one of Aspects 26 or 27, wherein generating the attestation data comprises estimating a location of the target device based on the measured distance and the angle of arrival.

Aspect 29. The method of Aspect 28, wherein generating the attestation data comprises: receiving location information, the location information indicating a location of the apparatus; and estimating a location of the target device based on the received location information, the estimated distance of the target device, and the angle of arrival.

Aspect 30. The method of Aspect 29, wherein the attestation data includes the estimated location of the target device.

Aspect 31. The method of any one of Aspects 29 or 30, wherein the received location information is in a universal transverse Mercator (UTM) format and further comprising: estimating the location of the target device based on the estimated distance of the target device and the angle of arrival; and projecting the estimated location of the target device to geolocation coordinates.

Aspect 32. The method of any of Aspects 24-31, further comprising receiving an identifier from the target device, and wherein the attestation data includes the received identifier.

Aspect 33. The method of Aspect 32, wherein the identifier comprises at least one of: a unique identifier of the target device; an assigned identifier assigned to the target device by the apparatus; and a ranging session identifier.

Aspect 34. The method of any of Aspects 24-33, wherein the attestation data comprises an attestation statement that is encrypted, signed, and includes data regarding an integrity of the apparatus.

Aspect 35. A method for delegated attestation by an apparatus, comprising: determining to verify a property of a target device; transmitting, to an attesting device, a request to perform delegated attestation of the target device; receiving, from the attesting device, attestation data, the attestation data including a property associated with a target device, wherein the attesting device is separate from the target device; and verifying the property associated with the target device based on an expected property of the target device.

Aspect 36. The method of Aspect 35, wherein the property of the target device comprises a location of the target device, and wherein the expected property of the target device comprises an expected location of the target device.

Aspect 37. The method of Aspect 36, wherein the location of the target device is based on a location of the attesting device.

Aspect 38. The method of Aspect 37, wherein the attestation data further includes the location of the attesting device, and wherein the method further comprises determining whether the location of the target device and the location of the attesting device are within a threshold distance.

Aspect 39. The method of any one of Aspects 36-38, further comprising comparing the location of the target device to the expected location of the target device.

Aspect 40. The method of Aspect 39, wherein the expected location of the target device comprises a previous location of the target device.

Aspect 41. The method of any of Aspects 35-40, wherein the attestation data includes an identifier associated with the target device.

Aspect 42. The method of Aspect 41, wherein the identifier comprises at least one of: a unique identifier of the target device; an assigned identifier assigned to the target device by the apparatus; and a ranging session identifier.

Aspect 43. The method of any of Aspects 35-42, wherein the attestation data further includes data regarding an integrity of the apparatus.

Aspect 44. The method of any of Aspects 35-43, wherein the expected property of the target device is received from the target device and wherein determining to verify the property of the target device comprises: receiving a request to access information; and determining to verify the property of the target device based on the request to access the information.

Aspect 45. The method of Aspect 44, wherein the expected property is received as attestation data from the target device.

Aspect 46. The method of any one of Aspects 44 or 45, further comprising providing the information based on verifying the property associated with the target device.

Aspect 47. A non-transitory computer-readable medium having stored thereon instructions that, when executed by at least one processor, cause the at least one processor to perform operations according to any of Aspects 24-46.

Aspect 48. An apparatus for delegated attestation, comprising one or more means for performing operations according to any of Aspects 24-46.

Aspect 51. An apparatus for delegated attestation, comprising: at least one memory comprising instructions; and at least one processor coupled to the at least one memory and configured to: receive an indication to attest to a property of a target device; generate a measurement associated with the property of the target device; generate data regarding an integrity of the apparatus; generate attestation data, the attestation data including information associated with the generated measurement and the generated data regarding the integrity of the apparatus; and transmit the attestation data to a verifier device.

Aspect 52. The apparatus of Aspect 51, wherein the property of the target device comprises a location of the target device.

Aspect 53. The apparatus of Aspect 52, wherein, to generate the measurement, the at least one processor is configured to: measure a distance to the target device; and measure an angle of arrival of the target device.

Aspect 54. The apparatus of Aspect 53, wherein, to generate the attestation data, the at least one processor is configured to determine a location of the target device based on the measured distance and the angle of arrival, and wherein the information associated with the generated measurement comprises the location of the target device.

Aspect 55. The apparatus of Aspect 54, wherein, to determine the location of the target device, the at least one processor is further configured to: receive location information, the location information indicating a location of the apparatus; and determine the location of the target device based on the received location information, the measured distance of the target device, and the angle of arrival.

Aspect 56. The apparatus of any of Aspects 54-55, wherein the attestation data includes the determined location of the target device.

Aspect 57. The apparatus of Aspect 56, wherein the information associated with the generated measurement includes the measured distance of the target device, and the angle of arrival.

Aspect 58. The apparatus of any of Aspects 55-57, wherein the received location information is in a universal transverse Mercator (UTM) format, and wherein the at least one processor is configured to: determining the location of the target device in the UTM format based on the measured distance of the target device and the angle of arrival; and project the determined location of the target device to geolocation coordinates.

Aspect 59. The apparatus of any of Aspects 51-58, wherein the at least one processor is configured to receive an identifier from the target device, and wherein the attestation data includes the received identifier.

Aspect 60. The apparatus of Aspect 59, wherein the identifier comprises at least one of: a unique identifier of the target device; an assigned identifier assigned to the target device by the apparatus; or a ranging session identifier.

Aspect 61. The apparatus of any of Aspects 51-60, wherein at least a portion of the attestation data is encrypted and signed.

Aspect 62. An apparatus for delegated attestation, comprising: at least one memory comprising instructions; and at least one processor coupled to the at least one memory and configured to: determine to verify a property of a target device; transmit, to an attesting device, a request to perform delegated attestation for the target device; receive attestation data, the attestation data including information associated with a property of a target device and data regarding an integrity of the attesting device, wherein the attesting device is separate from the target device; verify the integrity of the attesting device based on the data regarding the integrity of the attesting device; and verify the property associated with the target device based on an expected property of the target device.

Aspect 63. The apparatus of Aspect 62, wherein the property of the target device comprises a location of the target device, and wherein the expected property of the target device comprises an expected location of the target device.

Aspect 64. The apparatus of Aspect 63, wherein the location of the target device is based on a location of the attesting device.

Aspect 65. The apparatus of Aspect 64, wherein the attestation data further includes the location of the attesting device, wherein the expected location comprises the location of the attesting device, and wherein, to verify the property associated with the target device, the at least one processor is further configured to determine whether the location of the target device and the location of the attesting device are within a threshold distance.

Aspect 66. The apparatus of any of Aspects 63-65, wherein the at least one processor is further configured to compare the location of the target device to the expected location of the target device.

Aspect 67. The apparatus of Aspect 66, wherein the expected location of the target device is based on a previous location of the target device.

Aspect 68. The apparatus of any of Aspects 62-67, wherein the attestation data includes an identifier associated with the target device.

Aspect 69. The apparatus of Aspect 68, wherein the identifier comprises at least one of: a unique identifier of the target device; an assigned identifier assigned to the target device by the apparatus; and a ranging session identifier.

Aspect 70. The apparatus of any of Aspects 62-69, wherein the property of the target device comprises a location of the target device, wherein the attestation data further includes the location of the target device, wherein information associated with a property of a target device includes a measured distance of the target device, and an angle of arrival, and wherein the at least one processor is further configured to determine the location of the target device based on the location of the target device, the measured distance of the target device, and the angle of arrival.

Aspect 71. The apparatus of any of Aspects 62-70, wherein, to determine to verify the property of the target device, the at least one processor is further configured to: receive a request to access information; and determine to verify the property of the target device based on the request to access the information.

Aspect 72. The apparatus of Aspect 71, wherein the expected property of the target device is received from the target device, and wherein the expected property is received as attestation data from the target device.

Aspect 73. The apparatus of any of Aspects 71-72, wherein the at least one processor is configured to provide the information based on verifying the property associated with the target device.

Aspect 74. A method for delegated attestation by an apparatus, comprising: receiving an indication to attest to a property of a target device; generating a measurement associated with the property of the target device; generating data regarding an integrity of the apparatus; generating attestation data, the attestation data including information associated with the generated measurement and the generated data regarding the integrity of the apparatus; and transmitting the attestation data to a verifier device.

Aspect 75. The method of Aspect 74, wherein the property of the target device comprises a location of the target device.

Aspect 76. The method of Aspect 75, wherein generating the measurement comprises: measuring a distance to the target device; and measuring an angle of arrival of the target device.

Aspect 77. The method of Aspect 76, wherein generating the attestation data comprises determining a location of the target device based on the measured distance and the angle of arrival, and wherein the information associated with the generated measurement comprises the location of the target device.

Aspect 78. The method of Aspect 77, wherein determining the location of the target device comprises: receiving location information, the location information indicating a location of the apparatus; and determining the location of the target device based on the received location information, the measured distance of the target device, and the angle of arrival.

Aspect 79. The method of any of Aspects 77-78, wherein the attestation data includes the determined location of the target device.

Aspect 80. The method of Aspect 79, wherein the information associated with the generated measurement includes the measured distance of the target device, and the angle of arrival.

Aspect 81. The method of any of Aspects 78-80, wherein the received location information is in a universal transverse Mercator (UTM) format and further comprising: determining the location of the target device in the UTM format based on the measured distance of the target device and the angle of arrival; and projecting the determined location of the target device to geolocation coordinates.

Aspect 82. The method of any of Aspects 74-81, further comprising receiving an identifier from the target device, and wherein the attestation data includes the received identifier.

Aspect 83. The method of Aspect 82, wherein the identifier comprises at least one of: a unique identifier of the target device; an assigned identifier assigned to the target device by the apparatus; and a ranging session identifier.

Aspect 84. The method of any of Aspects 74-83, wherein at least a portion of the attestation data is encrypted and signed.

Aspect 85. A method for delegated attestation by an apparatus, comprising: determining to verify a property of a target device; transmitting, to an attesting device, a request to perform delegated attestation of the target device; receiving attestation data, the attestation data including information associated with a property of a target device and data regarding an integrity of the attesting device, wherein the attesting device is separate from the target device; verifying the integrity of the attesting device based on the data regarding the integrity of the attesting device; and verifying the property associated with the target device based on an expected property of the target device.

Aspect 86. The method of Aspect 85, wherein the property of the target device comprises a location of the target device, and wherein the expected property of the target device comprises an expected location of the target device.

Aspect 87. The method of Aspect 86, wherein the location of the target device is based on a location of the attesting device.

Aspect 88. The method of Aspect 87, wherein the attestation data further includes the location of the attesting device, wherein the expected location comprises the location of the attesting device, and wherein verifying the property associated with the target device comprises determining whether the location of the target device and the location of the attesting device are within a threshold distance.

Aspect 89. The method of any of Aspects 86-88, further comprising comparing the location of the target device to the expected location of the target device.

Aspect 90. The method of Aspect 89, wherein the expected location of the target device is based on a previous location of the target device.

Aspect 91. The method of any of Aspects 85-90, wherein the attestation data includes an identifier associated with the target device.

Aspect 92. The method of Aspect 91, wherein the identifier comprises at least one of: a unique identifier of the target device; an assigned identifier assigned to the target device by the apparatus; and a ranging session identifier.

Aspect 93. The method of any of Aspects 85-92, wherein the property of the target device comprises a location of the target device, wherein the attestation data further includes the location of the target device, wherein information associated with a property of a target device includes a measured distance of the target device, and an angle of arrival, and wherein the method further comprises determining the location of the target device based on the location of the target device, the measured distance of the target device, and the angle of arrival.

Aspect 94. The method of any of Aspects 85-93, wherein determining to verify the property of the target device comprises: receiving a request to access information; and determining to verify the property of the target device based on the request to access the information.

Aspect 95. The method of Aspect 94, wherein the expected property of the target device is received from the target device, and wherein the expected property is received as attestation data from the target device.

Aspect 96. The method of any of Aspects 94-95, further comprising providing the information based on verifying the property associated with the target device.

Aspect 97. A non-transitory computer-readable medium having stored thereon instructions that, when executed by at least one processor, cause the at least one processor to perform operations according to any of Aspects 62-96 and 102-103.

Aspect 98. An apparatus for delegated attestation, comprising one or more means for performing operations according to any of Aspects 62-96 and 102-103.

Aspect 99. The apparatus of Aspect 51, wherein the property of the target device comprises a property of the target device perceptible by the apparatus.

Aspect 100. The apparatus of Aspect 55, wherein the location of the target device is determined based on the received location information, the measured distance of the target device, and the angle of arrival by applying a Haversine formula.

Aspect 101. The apparatus of Aspect 51, wherein the data regarding the integrity of the apparatus includes at least one of: versioning information; file hash; information about installed applications; signature information; hardware identification numbers; and event records.

Aspect 101. The method of Aspect 74, wherein the property of the target device comprises a property of the target device perceptible by the apparatus.

Aspect 102. The method of Aspect 78, wherein the location of the target device is determined based on the received location information, the measured distance of the target device, and the angle of arrival by applying a Haversine formula.

Aspect 103. The method of Aspect 74, wherein the data regarding the integrity of the apparatus includes at least one of: versioning information; file hash; information about installed applications; signature information; hardware identification numbers; and event records.

Aspect 104. The apparatus of Aspect 73, wherein the at least one processor is configured to provide the information based on verifying the integrity of the attesting device.

What is claimed is:

1. An apparatus for delegated attestation, comprising:
at least one memory comprising instructions; and
at least one processor coupled to the at least one memory and configured to:
receive an indication to attest to a property of a target device;
generate a measurement associated with the property of the target device;
generate data regarding an integrity of the apparatus;
generate attestation data, the attestation data including information associated with the generated measurement and the generated data regarding the integrity of the apparatus; and
transmit the attestation data to a verifier device.

2. The apparatus of claim 1, wherein the property of the target device comprises a property of the target device perceptible by the apparatus.

3. The apparatus of claim 2, wherein the property of the target device comprises a location of the target device.

4. The apparatus of claim 3, wherein, to generate the measurement, the at least one processor is configured to:
measure a distance to the target device; and
measure an angle of arrival of the target device.

5. The apparatus of claim 4, wherein, to generate the attestation data, the at least one processor is configured to determine a location of the target device based on the measured distance and the angle of arrival, and wherein the information associated with the generated measurement comprises the location of the target device.

6. The apparatus of claim 5, wherein, to determine the location of the target device, the at least one processor is further configured to:
receive location information, the location information indicating a location of the apparatus; and
determine the location of the target device based on the received location information, the measured distance of the target device, and the angle of arrival.

7. The apparatus of claim 5, wherein the attestation data includes the determined location of the target device.

8. The apparatus of claim 7, wherein the information associated with the generated measurement includes the measured distance of the target device, and the angle of arrival.

9. The apparatus of claim 6, wherein the received location information is in a universal transverse Mercator (UTM) format, and wherein the at least one processor is configured to:
determine the location of the target device in the UTM format based on the measured distance of the target device and the angle of arrival; and
project the determined location of the target device to geolocation coordinates.

10. The apparatus of claim 1, wherein the at least one processor is configured to receive an identifier from the target device, and wherein the attestation data includes the received identifier.

11. The apparatus of claim 10, wherein the identifier comprises at least one of:
a unique identifier of the target device;
an assigned identifier assigned to the target device by the apparatus; or
a ranging session identifier.

12. The apparatus of claim 1, wherein at least a portion of the attestation data is encrypted and signed.

13. The apparatus of claim 1, wherein the data regarding the integrity of the apparatus includes at least one of:
versioning information;
file hash;
information about installed applications;
signature information;
hardware identification numbers; and
event records.

14. An apparatus for delegated attestation, comprising:
at least one memory comprising instructions; and
at least one processor coupled to the at least one memory and configured to:
determine to verify a property of a target device;
transmit, to an attesting device, a request to perform delegated attestation for the target device;
receive attestation data, the attestation data including information associated with a property of a target device and data regarding an integrity of the attesting device, wherein the attesting device is separate from the target device;
verify the integrity of the attesting device based on the data regarding the integrity of the attesting device; and
verify the property associated with the target device based on an expected property of the target device.

15. The apparatus of claim 14, wherein the property of the target device comprises a location of the target device, and wherein the expected property of the target device comprises an expected location of the target device.

16. The apparatus of claim 15, wherein the location of the target device is relative to a location of the attesting device.

17. The apparatus of claim 16, wherein the attestation data further includes the location of the attesting device, wherein the expected location comprises the location of the attesting device, and wherein, to verify the property associated with the target device, the at least one processor is further configured to determine whether the location of the target device and the location of the attesting device are within a threshold distance.

18. The apparatus of claim 15, wherein the at least one processor is further configured to compare the location of the target device to the expected location of the target device.

19. The apparatus of claim 18, wherein the expected location of the target device is based on a previous location of the target device.

20. The apparatus of claim 14, wherein the attestation data includes an identifier associated with the target device.

21. The apparatus of claim 20, wherein the identifier comprises at least one of:
a unique identifier of the target device;
an assigned identifier assigned to the target device by the apparatus; and
a ranging session identifier.

22. The apparatus of claim 14, wherein the property of the target device comprises a location of the target device, wherein the attestation data further includes the location of the target device, wherein information associated with a property of a target device includes a measured distance of the target device, and an angle of arrival, and wherein the at least one processor is further configured to determine the location of the target device based on the location of the target device, the measured distance of the target device, and the angle of arrival.

23. The apparatus of claim 14, wherein, to determine to verify the property of the target device, the at least one processor is further configured to:
receive a request to access information; and
determine to verify the property of the target device based on the request to access the information.

24. The apparatus of claim 23, wherein the expected property of the target device is received from the target device, and wherein the expected property is received as attestation data from the target device.

25. The apparatus of claim 23, wherein the at least one processor is configured to provide the information based on verifying the property associated with the target device.

26. The apparatus of claim 25, wherein the at least one processor is configured to provide the information based on verifying the integrity of the attesting device.

27. A method for delegated attestation by an apparatus, comprising:
receiving an indication to attest to a property of a target device;
generating a measurement associated with the property of the target device;
generating data regarding an integrity of the apparatus;
generating attestation data, the attestation data including information associated with the generated measurement and the generated data regarding the integrity of the apparatus; and
transmitting the attestation data to a verifier device.

28. The method of claim 27, wherein the property of the target device comprises a location of the target device.

29. The method of claim 28, wherein generating the measurement comprises:
measuring a distance to the target device; and
measuring an angle of arrival of the target device.

30. The method of claim 29, wherein generating the attestation data comprises determining a location of the target device based on the measured distance and the angle of arrival, and wherein the information associated with the generated measurement comprises the location of the target device.
